(19) United States
(12) Patent Application Publication
(10) Pub. No.: US 2025/0134227 A1
(43) Pub. Date: May 1, 2025

(54) HAIR STYLING DEVICE

(71) Applicant: Dyson Technology Limited, Wiltshire (GB)

(72) Inventors: Daniel James Bernard SMITH, Newcastle upon Tyne (GB); Barrie Charles MECROW, Newcastle upon Tyne (GB); Mark TURNER, Newcastle upon Tyne (GB)

(21) Appl. No.: 18/689,486

(22) PCT Filed: Sep. 7, 2022
(86) PCT No.: PCT/GB2022/052272

§ 371 Date: Mar. 6, 2024

(30) Foreign Application Priority Data
Sep. 10, 2021 (GB) 2112915.0

(51) Int. Cl. A45D 2/00; H05B 6/10; H05B 6/36

(52) U.S. Cl. CPC A45D 2/001; H05B 6/105; H05B 6/36; H05B 2206/024

(57) ABSTRACT

A hair styling device for heating hair is provided. The device comprises an induction heating plate arranged to be heated by penetration with a varying magnetic field and an induction heating assembly configured to generate the varying magnetic field.

### TECHNICAL FIELD

The present invention relates to a hair styling device, and particularly to a hair styling device for heating hair. The invention may find particular use in a hair straightening device.

### BACKGROUND

A hair styling device is a device comprising a heating assembly for styling hair by heating the hair above a certain temperature and causing the hair to retain a shape imparted to it. Hair styling devices can include hair straightening devices used to straighten hair, or hair curling devices used to curl hair, for example.

Existing hair styling devices typically include resistive heating assemblies which produce heat by passing an electric current through a conductor. These conductors are then placed in thermal proximity to a heating plate, which heats up and is brought into contact with hair. Hair styling devices with resistive heating assemblies can take a relatively long time to heat up, which can frustrate users, and can take a relatively long time to cool down, which can pose safety issues. Accordingly, what is needed is a hair styling device that overcomes these problems.

### SUMMARY

According to certain aspects, the present invention defines a hair styling device comprising an induction heating assembly. Induction heating is a process whereby an electrically conducting object is heated by electromagnetic induction in which a varying/alternating magnetic field is produced. The magnetic field penetrates the electrically conductive object, in this case an induction heating plate, and induces eddy currents within the object. These eddy currents flow through the object and heat the object via Joule heating. In some examples, the object may also be ferromagnetic, such that additional heat is generated by magnetic hysteresis. Thus, unlike hair styling devices having resistive heating assemblies, heat is generated within the heating plate itself meaning that the heating plate is heated rapidly. Similarly, turning off the magnetic field removes the heat source immediately, so that the heating plate can cool down faster.

In a first aspect of the present invention, there is provided a hair styling device for heating hair, comprising an induction heating plate arranged to be heated by penetration with a varying magnetic field and an induction heating assembly having a top side facing towards the heating plate, and a bottom side facing away from the heating plate, wherein the induction heating assembly is configured to generate a varying magnetic field, the varying magnetic field being asymmetric such that the magnetic field strength at the top side is substantially greater than the magnetic field strength at the bottom side.

In one example, a ratio of the magnetic field strength at the top side to the magnetic field strength at the bottom side is greater than about 100. More preferably, the ratio of the magnetic field strength at the top side to the magnetic field strength at the bottom side is greater than about 1000.

More particularly, the induction heating assembly may comprise an inductor coil assembly, and it is the inductor coil assembly that has the top side facing towards the heating plate, and the bottom side facing away from the heating plate.

Accordingly, the hair styling device has an induction heating assembly that produces a substantially “single-sided” magnetic field in which there is a strong magnetic field produced only at the top side of the induction heating assembly. Preferably there is no magnetic field produced at the bottom side of the induction heating assembly, or the magnetic field strength at the bottom is small or negligible compared to the magnetic field strength at the top side. Thus, a high proportion of the magnetic energy is directed towards the induction heating plate. This asymmetric, or single-sided, magnetic field therefore provides a more energy efficient heating process by reducing the amount magnetic energy being lost in other directions. Energy efficiency is particularly important when the hair styling device comprises a battery power source to power the induction heating assembly. Thus, in some examples, the hair styling device comprises a battery power source. The single-sided or asymmetric magnetic field may be analogous to a Halbach array of permanent magnets.

In addition, because the magnetic field is directed substantially towards the induction heating plate, the magnetic flux escaping the device is greatly reduced. This reduces the need for bulky, heavy and expensive magnetic shielding to be included in the hair styling device. The device can therefore be made safer, without compromising on size and portability. The use of an asymmetric magnetic field can allow the hair styling device to meet certain consumer product safety standards (such as IEC 60335) with no or minimal magnetic shielding. Thus, the use of an asymmetric magnetic field finds particular advantages in a hair styling device which is brought into close proximity to a user's head and/or jewellery.

In some examples, the induction heating assembly comprises at least one inductor coil. The inductor coil may form part of an inductor coil assembly, for example. The inductor coil generates a magnetic field when a current is passed through the coil. The hair styling device may further comprise a drive circuit configured to generate an alternating current to pass through the induction heating assembly to produce a varying magnetic field. The frequency of the alternating current may be known as the drive frequency. In some examples, the induction heating assembly comprises a resonant circuit driven by the drive circuit, where the resonant circuit comprises the at least one inductor coil. In some examples, the drive circuit is configured to supply alternating current at the drive frequency according to a drive signal.

In one example, the induction heating assembly comprises a plurality of heating zones, each heating zone being arranged to generate a varying magnetic field to heat a respective region of the heating plate. In certain arrangements, each heating zone is independently controllable.

The induction heating assembly may therefore comprise a plurality of heating zones each capable of generating its own magnetic field, such as an asymmetric magnetic field, to heat a particular region of the heating plate. Thus, different regions of the heating plate can be heated to different temperatures and/or at different times. The use of multiple heating zones therefore improves control. For example, by controlling each heating zone independently, each region of the heating plate can be maintained at a particular temperature to avoid overheating regions that do not have good thermal contact with hair.

Each heating zone may comprise an inductor coil assembly (as part of a resonant circuit, for example) and a drive circuit. The hair styling device may further comprise a controller to control operation of the plurality of heating zones. The controller may comprise one or more processors, including one or more microprocessors, central processing units and/or graphical processing units, and a set of memory.

In some examples, the heating plate is flexible. Thus, when the heating plate is brought into contact with hair the heating plate flexes and conforms to the hair to ensure the hair is heated uniformly.

In a particular arrangement, the heating plate is moveable between a first position and a second position, the second position being closer to the heating assembly than the first position. Thus, the heating plate can flex between the first and second positions. The heating plate may be biased towards the first position in the absence of a force applied by hair and may be deflected towards the second position in the presence of a force applied by hair. The heating plate in the first position may be substantially flat, and may curve or bend towards the second position when hair is introduced which forces the heating plate into the second position. When the heating plate is arranged in the first position, it may be said to be “unflexed”. When the heating plate is arranged in the second position, it may be said to be “flexed”.

In one arrangement, the plurality of heating zones comprises a first heating zone driven at a first drive frequency, such that when a first region of the heating plate heated by the first heating zone is arranged in the first position, the first heating zone has an initial resonant frequency and when the first region is arranged in the second position, the first heating zone has a final resonant frequency, wherein the difference between the final resonant frequency and the first drive frequency is smaller than the difference between the initial resonant frequency and the first drive frequency, thereby causing resonant heating of the first region. This means that as the first region of the heating plate flexes towards the second position, the first region is heated to a higher a temperature due to the drive frequency being closer the resonant frequency of the first heating zone than when the heating plate is in the first position. This arrangement takes advantage of the fact that the resonant frequency of the system varies based on the proximity of the heating plate to the induction heating assembly. Thus, as a region of the heating plate moves towards a particular heating zone of the induction heating assembly, the resonant frequency of the heating zone changes.

The drive frequency of the first heating zone can be selected so that resonant heating occurs when the first region flexes in the presence of hair. When the hair is removed, the first region returns to the unflexed/undeflected position, and the heating plate is no longer heated resonantly. Thus, when hair is present, the heating plate flexes into a position in which resonant heating is affected, and the heating plate increases in temperature. When no hair (or less hair) is present, the heating plate is relatively unflexed, and resonant heating does not occur, so the heating plate is maintained at a lower temperature. This means that the presence of hair can cause the induction heating assembly to begin significant heating in that particular region of the heating plate. This arrangement can improve the safety of the device by only heating the plate to a high temperature when hair is present. This avoids accidental burns or fires should the hair styling device be left switched on.

Perfect resonant heating is achieved when the drive frequency matches the resonant frequency of the heater zone. For example, when the final resonant frequency is substantially the same as the first drive frequency. However, it will be understood that an increased heating effect (i.e. a greater temperature) can be achieved in the second (flexed) position compared to the first (undeflected) position by ensuring that the difference between the resonant frequency in the second position and the drive frequency is smaller than the difference between the resonant frequency in the second position and the first drive frequency. Thus, perfect resonance is not necessarily required to achieve the benefits of the invention.

In some examples, the plurality of heating zones comprises a second heating zone driven at a second drive frequency, wherein when the first region is arranged in the first position, a second region of the heating plate heated by the second heating zone is arranged in the first position, and the second heating zone has an initial resonant frequency. When the first region is arranged in the second position, the second region remains substantially in the first position and the second heating zone has a final resonant frequency substantially the same as the initial resonant frequency, and the second drive frequency is substantially different to the final resonant frequency, so as not to cause resonant heating of the second region. In other words, when both the first and second regions of the heating plate are undeflected, neither region is heated to a great extent. However, when hair is present in only the first region, the first region flexes, and the second region remains undeflected. This means that when hair is present in only the first region, only the first region of the heating plate is heated. Thus, separate regions of the heating plate can be heated independently which avoids other regions of the heating plate being heated if there is no hair present. In some examples, the first and second regions are adjacent to each other along the surface of the heating plate. By only heating the first region when there is no hair located in the second region, the first region is less likely to overheat (which can burn the hair) as a result of additional heat flowing from the second region. It will be appreciated that if the first and second heating zones are close to each other (such as directly adjacent) the heating plate in the second region may exhibit some flex, but to an extent that is less than the flex in the first region such that heating in the second region is less than the first heating zone. Additionally, or alternatively there may be less hair in the second region, so the second region may flex to some degree, but it may not be heated to the extent of the first region.

In some examples, the first and second drive frequencies are substantially the same. In other examples, the first and second drive frequencies can be independently selected, and may be different.

In some examples, the drive frequency of each heating zone remains constant as the heating plate moves between the first and second positions. This provides a simple way of controlling the degree of heating, but assumes that the heating plate in the vicinity of each heating zone will flex by the same amount each time if resonant heating is required. This therefore assumes that the drive frequency will match resonant frequency in the particular heating zone as the plate flexes. However, this may not always be the case. For example, in some circumstances, the heating plate may not fully flex, so the resonant frequency does not match the drive frequency and the heating plate is heated less efficiently. In addition, each device that is manufactured will have different components and so the resonant frequency and optimal drive frequency will need to be determined for every device. The resonant frequency may also change over time, as components of the device age. To overcome this, in some examples, the drive frequency can be varied or adjusted to ensure that it more closely matches the resonant frequency of the heating zone.

As mentioned, in some examples, each heating zone may comprise a drive circuit and a resonant circuit, where the resonant circuit comprises the inductor coil assembly. The drive frequency can be controlled by a drive signal supplied to the drive circuit (from a controller, for example).

To achieve resonant heating of the heating plate, the drive frequency can be selected to match the resonant frequency of the heating zone/resonant circuit. It may therefore be desirable to determine/calculate the resonant frequency of the resonant circuit and adjust the drive frequency appropriately. However, it has been found that calculating the resonant frequency directly can be processor intensive, especially if this is performed many times per second. It has been found that it is more computationally efficient to infer the drive frequency by determining/measuring a phase difference between the resonant circuit current (or voltage) and the drive signal, and varying the drive frequency until this phase difference matches a predetermined phase difference. This “predetermined phase difference” is a phase difference between a current or voltage of the resonant circuit and the drive signal when the resonant circuit is resonant, and may be determined in advance. This relies on the fact that when the resonant circuit is resonant, the predetermined phase difference has the same value, regardless of the heating plate position. This means that when the measured phase difference matches this predetermined phase difference, it can be inferred that the drive frequency corresponds to the resonant frequency.

Accordingly, in some examples, the first heating zone comprises a drive circuit configured to supply alternating current at a drive frequency according to a drive signal, and a resonant circuit driven by the drive circuit, the resonant circuit being arranged to heat the first region of the heating plate. The hair styling device further comprises a controller configured to, when the first region is arranged in the second position:
supply the drive circuit with a particular drive signal, thereby causing the drive circuit to supply alternating current at a particular drive frequency;
determine a phase difference between a current or voltage of the resonant circuit and the particular drive signal; and
determine whether the phase difference corresponds to a predetermined phase difference.
   If the phase difference corresponds to the predetermined phase difference, the controller is configured to determine that the particular drive frequency corresponds to a resonant frequency of the resonant circuit. If the phase difference does not correspond to the predetermined phase difference, the controller is configured to supply the drive circuit with a different drive signal, thereby causing the drive circuit to supply alternating current at a different drive frequency. Different drive signals and drive frequencies can be iterated through until it is determined that the phase difference corresponds to the predetermined phase difference.

In one example, the drive signal is a signal sent to the drive circuit (such as a driver of the drive circuit) to control the rate at which a current is applied from a DC voltage source to the resonant circuit. In certain arrangements the drive circuit also comprises a switch, and the drive signal therefore controls the rate at which the switch is operated. In one example, the drive signal has a 50% duty cycle. In one example, the drive signal has the form of a square wave. The controller can vary the drive frequency by altering a frequency characteristic of the drive signal.

“Corresponds to” may mean that the determined phase difference is within a specific range of the predetermined phase difference, and does not necessarily mean that the phase differences exactly correspond.

“Supply the drive circuit with a particular drive signal” may comprise causing the particular drive signal to be received by the drive circuit, such as a driver.

“Determine a phase difference between a current or voltage of the resonant circuit and the particular drive signal” may comprise measuring and/or calculating the current and/or voltage within the resonant circuit. The determined phase difference may be known as a measured phase difference in certain examples.

As briefly mentioned above, in some examples, the predetermined phase difference is a phase difference between a current or voltage of the resonant circuit and the drive signal when the resonant circuit is resonant. It can be shown/observed that the phase difference at resonance (for a given circuit) remains substantially the same regardless of the resonant frequency. Accordingly, if the measured phase difference matches the predetermined phase difference at resonance, it can be inferred that the drive frequency matches the resonant frequency. This means that the heating plate can be heated resonantly by selecting a drive frequency that results in the measured phase difference matching this predetermined phase difference at resonance. Thus, when the resonant circuit is resonant, the predetermined phase difference is independent of the heating plate position. “When the resonant circuit is resonant” means that the drive frequency matches/corresponds to the resonant frequency of the resonant circuit (or heating zone). “When the resonant circuit is resonant” can also mean that the heating plate (in a particular region) is heated resonantly. The resonant frequency of the resonant circuit depends on the heating plate position.

The resonant circuit may comprise at least one capacitor and at least one inductor. The resonant circuit may be known as an RLC circuit.

In some examples, once it has been determined that the phase difference corresponds to the predetermined phase difference, the particular drive frequency is maintained (for at least a predetermined period of time).

The steps of determining a phase difference between a current or voltage of the resonant circuit and the particular drive signal, and determining whether the phase difference corresponds to a predetermined phase difference may be performed periodically. This allows the drive frequency to be adjusted should it be determined that the phase difference no longer corresponds to the predetermined phase difference, thereby maintaining resonant heating. The phase difference may no longer correspond to the predetermined phase difference because the degree of heating plate flex may change, which alters the resonant frequency of the resonant circuit. This causes the difference between the drive frequency and resonant frequency to change, which alters the measured phase difference.

The predetermined phase difference may be stored in memory, such as a memory of the controller.

The predetermined phase difference can be determined prior to operation, either empirically or via a simulation. In a first example, the predetermined phase difference is calculated via a computer simulation. For example, the drive circuit and resonant circuit can be modelled in a computer software package. The modelled circuit can be driven to resonance, and the phase difference can be determined by “measuring” the resonant circuit current/voltage. This modelled phase difference at resonance is therefore the target predetermined phase difference.

In a second example, the controller is configured to determine the predetermined phase difference when the first region is arranged in the first position, by being configured to:
supply the drive circuit with a particular drive signal, thereby causing the drive circuit to supply alternating current at a particular drive frequency, the particular drive frequency being sufficiently far from an estimated resonant frequency of the resonant circuit;
determine a measured phase difference between a current or voltage of the resonant circuit and the particular drive signal; and
determine the predetermined phase difference as being the measured phase difference offset by 90 degrees.

It can be shown that when the drive frequency matches the resonant frequency, the phase difference shifts by 90 degrees from an initial phase difference that is measured when the drive frequency is sufficiently far from the resonant frequency of the resonant circuit. Theory and experimental data show that at drive frequencies far from the resonant frequency, the phase difference plateaus and remains relatively constant. At resonance, the measured phase difference is 90 degrees offset from this phase difference. Accordingly, the phase difference at resonance (i.e. the predetermined phase difference) can be determined from the phase difference observed at a drive frequency far from the resonant frequency. In a particular example, a drive frequency sufficiently far from the resonant frequency, is around 100 times larger or smaller than the resonant frequency.

The process of matching the drive frequency to the resonant frequency of the heater zone based on the phase difference may be applied to other hair styling devices, such as those having an induction heating assembly with only one heating zone, and/or an induction heating assembly that does not have an asymmetric magnetic field.

In some examples, it may be useful to stop heating the heating plate if it is determined that the heating plate is not flexed. It may therefore be assumed that there is no hair present. One or more heating zones may therefore cease to heat their respective regions of the heating plate. This can reduce energy consumption, which is particularly important in battery operated devices and improve safety.

Accordingly, in some examples, the controller is configured to determine whether a region (such as the first region) of the heating plate is arranged in the first position or the second position. If it is determined that the heating plate is arranged in the first position (i.e. is unflexed, or minimally flexed), the controller is configured cause the first heating zone to cease generating a magnetic field. Thus, if no magnetic field is generated, the first region of the heating plate will not be heated.

The controller may be configured to determine whether the first region of the heating plate is arranged in the first position or the second position periodically, such as every second. Thus, if the heating plate does begin to flex, the heating zone can begin generating the magnetic field again.

Determining whether the heating plate is arranged in the first position or the second position may comprise determining an impedance of an inductor coil assembly in a heating zone. It has been found that the impedance of the inductor coil assembly varies based on the degree of heating plate flex. Accordingly, in some arrangements, the resonant circuit comprises an inductor coil assembly, and the controller is configured to determine whether the first region of the heating plate is arranged in the first position or the second position based on a comparison of an impedance of the inductor coil assembly with a reference impedance. The reference impedance may be an impedance of the inductor coil assembly when the first region of the heating plate is arranged in a particular position, such as the first position or second position, for example. The impedance of the inductor coil assembly may be known as a measured impedance.

In one example, the reference impedance is an impedance of the inductor coil assembly when the first region of the heating plate is arranged in the first position, and if the measured impedance of the inductor coil assembly substantially corresponds to the reference impedance, then it may be determined that the heating plate is arranged in the first position. If the measured impedance of the inductor coil assembly does not correspond to the reference impedance (i.e. differs by a predetermined amount), it may be determined that the heating plate is arranged in the second position.

In another example, the reference impedance is an impedance of the inductor coil assembly when the first region of the heating plate is arranged in the second position, and if the measured impedance of the inductor coil assembly substantially corresponds to the reference impedance, then it may be determined that the heating plate is arranged in the second position. If the measured impedance of the inductor coil assembly does not correspond to the reference impedance (i.e. differs by a predetermined amount), it may be determined that the heating plate is arranged in the first position.

Additionally or alternatively, determining whether the heating plate is arranged in the first position or the second position may comprise determining the power delivered to the resonant circuit by the drive circuit when the resonant circuit is resonant (i.e. when the drive frequency corresponds to the resonant frequency of the resonant circuit). As mentioned above, ensuring that the resonant circuit is resonant can be achieved by matching the phase difference to a predetermined phase difference. It has been found that the power delivered to the resonant circuit at resonance varies based on the degree of heating plate flex.

Accordingly, in some arrangements, the controller is configured to determine whether the first region of the heating plate is arranged in the first position or the second position by being configured to:
determine an average power supplied by the drive circuit when the when the resonant circuit is resonant; and
determine whether the first region of the heating plate is arranged in the first position or the second position based on a comparison of the average power to a reference power.

The reference power may be the average power supplied by the drive circuit when: (i) the first region of the heating plate is arranged in the first position (or second position), and (ii) the resonant circuit is resonant. The average power supplied by the drive circuit when the resonant circuit is resonant may be known as a measured average power.

In one example, the reference power is the average power supplied by the drive circuit when the first region of the heating plate is arranged in the first position, and is heated resonantly, and if the measured average power substantially corresponds to the reference power, then it may be determined that the heating plate is arranged in the first position. If the measured average power does not correspond to the reference power (i.e. differs by a predetermined amount), it may be determined that the heating plate is arranged in the second position.

In another example, the reference power is the average power supplied by the drive circuit when the first region of the heating plate is arranged in the second position, and is heated resonantly, and if the measured average power substantially corresponds to the reference power, then it may be determined that the heating plate is arranged in the second position. If the measured average power does not correspond to the reference power (i.e. differs by a predetermined amount), it may be determined that the heating plate is arranged in the first position.

The reference impedance and/or reference power may be determined prior to operation. For example, the reference impedance/power can be determined/measured when the device is initially switched, when the heating plate is arranged in the first position. The reference impedance/power may be determined periodically, and may be updated over time. The reference impedance/power may be stored in memory, such as a memory of the controller.

This method of determining whether the heating plate is arranged in the first or second position may be applied to other hair styling devices, such as those having an induction heating assembly with only one heating zone, and/or an induction heating assembly that does not have an asymmetric magnetic field.

In some examples, the surface of the heating plate that contacts the hair may have continuous surface. However, as briefly mentioned, it may sometimes be useful to limit heat flow between regions on the heating plate to avoid overheating. Accordingly, in some examples, the first and second regions are separated by an insulating boundary to reduce heat flow between the first and second regions. In a particular arrangement, the insulating boundary comprises a groove formed on the heating plate. The surface of the heating plate that contacts the hair may therefore have non-continuous surface.

In some examples, the hair styling device further comprises a battery power source to power the induction heating assembly.

In a second aspect of the present invention there is provided a hair styling device for heating hair, comprising a flexible induction heating plate configured to be heated by penetration with a varying magnetic field and an induction heating assembly configured to generate a varying magnetic field, the induction heating assembly comprising a first heating zone to heat a first region of the heating plate, and a second heating zone to heat a second region of the heating plate. The first and second regions of the heating plate are independently moveable between a first position and a second position, the second position being closer to the heating assembly than the first position, wherein the first and second regions are biased towards the first position in the absence of a force applied by hair and are deflected towards the second position in the presence of a force applied by hair. When the first and second regions of the heating plate are arranged in the first position the first and second heating zones have a resonant frequency substantially different to a drive frequency driving the first and second heating zones so as not to cause resonant heating of the first and second regions and when the first region is arranged in the second position and the second region remains substantially in the first position the difference between a resonant frequency of the first heating zone in the second position and the drive frequency is smaller than the difference between the resonant frequency of the first heating zone in the first position and the drive frequency, so as to cause resonant heating of the first region, and the second heating zone maintains a resonant frequency substantially different to the drive frequency so as not to cause resonant heating of the second region.

Thus, as explained previously, the induction heating plate can flex such that at least one region of the heating plate moves into a position in which resonant heating occurs while at least one other region of the heating plate remains substantially unflexed such that resonant heating does not occur. Regions in which resonant heating occurs are heated to a higher temperature than those which are not heated resonantly.

Additional features described in any other aspect of the invention may be incorporated into the second aspect.

In a third aspect of the present invention there is provided a hair styling device for heating hair, comprising an induction heating plate configured to be heated by penetration with a varying magnetic field and an induction heating assembly configured to generate a varying magnetic field, the induction heating assembly comprising a first heating zone to heat a first region of the heating plate and a second heating zone to heat a second region of the heating plate, wherein the first and second regions are adjacent and the first and second regions are separated by an insulating boundary to reduce heat flow between the first and second regions.

In a particular example, the insulating boundary comprises a groove formed on the heating plate. Additional features described in any other aspect of the invention may be incorporated into the fourth aspect.

In a fourth aspect of the present invention there is provided a hair styling device for heating hair, comprising:
a flexible induction heating plate configured to be heated by penetration with a varying magnetic field;
an induction heating assembly comprising:
   a drive circuit configured to supply alternating current at a drive frequency according to a drive signal; and
   a resonant circuit driven by the drive circuit, the resonant circuit being arranged to generate a varying magnetic field for heating the heating plate; and a controller;
      wherein:
the heating plate is moveable between a first position and a second position, the second position being closer to the induction heating assembly than the first position, wherein the heating plate is biased towards the first position in the absence of a force applied by hair and is deflected towards the second position in the presence of a force applied by hair; and
the controller is configured to, when the heating plate is arranged in the second position:
supply the drive circuit with a particular drive signal, thereby causing the drive circuit to supply alternating current at a particular drive frequency;
determine a phase difference between a current or voltage of the resonant circuit and the particular drive signal;
determine whether the phase difference corresponds to a predetermined phase difference; and
if the phase difference corresponds to the predetermined phase difference:
   determine that the particular drive frequency corresponds to a resonant frequency of the resonant circuit; and
if the phase difference does not correspond to the predetermined phase difference:
   supply the drive circuit with a different drive signal, thereby causing the drive circuit to supply alternating current at a different drive frequency.

In some examples, the drive circuit and resonant circuit form part of a heating zone. The induction heating assembly may comprise one or more heating zones.

Any or all of the features described in the other aspects of the invention may be incorporated into the fourth aspect.

In a fifth aspect of the present invention there is provided a hair styling device for heating hair, comprising:
a flexible induction heating plate configured to be heated by penetration with a varying magnetic field;
an induction heating assembly comprising:
   a drive circuit configured to supply alternating current at a drive frequency according to a drive signal; and
   a resonant circuit driven by the drive circuit, the resonant circuit being arranged to generate a varying magnetic field for heating the heating plate; and
a controller;
   wherein:
the heating plate is moveable between a first position and a second position, the second position being closer to the induction heating assembly than the first position, wherein the heating plate is biased towards the first position in the absence of a force applied by hair and is deflected towards the second position in the presence of a force applied by hair; and
the controller is configured to determine whether the heating plate is arranged in the first position or the second position.

In some examples, the drive circuit and resonant circuit form part of a heating zone. The induction heating assembly may comprise one or more heating zones.

Any or all of the features described in the other aspects of the invention may be incorporated into the fifth aspect.

In some examples, the resonant circuit comprises an inductor coil assembly, and wherein the controller is configured to determine whether the heating plate is arranged in the first position or the second position based on a comparison of an impedance of the inductor coil assembly with a reference impedance.

In some examples, the controller is configured to determine whether the heating plate is arranged in the first position or the second position by being configured to:
determine an average power supplied by the drive circuit when the when the resonant circuit is resonant; and determine whether the heating plate is arranged in the first position or the second position based on a comparison of the average power to a reference power.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a perspective view of a hair straightening device according to an example;

FIG. 2 is a schematic cross-sectional view of an arm of the hair straightening device of FIG. 1;

FIG. 3 is a schematic diagram of an asymmetric magnetic field;

FIG. 4 is perspective view of an induction heating assembly and induction heating plate according to an example;

FIG. 5A is a schematic diagram of a flexible heating plate arranged in a first, unflexed position;

FIG. 5B is a schematic diagram of a flexible heating plate arranged in a second, flexed position;

FIG. 6A is a schematic diagram of a flexible heating plate arranged in a first, unflexed position, where the heating plate is heated by a plurality of heating zones;

FIG. 6B is a schematic diagram of a flexible heating plate arranged in a second, flexed position, where the heating plate is heated by a plurality of heating zones;

FIG. 7 is a circuit diagram representative of a drive circuit, an induction heating assembly and a heating plate;

FIG. 8 is a plot of the resonant circuit current over time;

FIG. 9 is a plot of phase difference against drive frequency;

FIG. 10 is a schematic diagram of a heating plate having a continuous heating surface;

FIG. 11 is a schematic diagram of a heating plate having insulating boundaries between regions on the heating surface; and

FIG. 12 is a heat map of the heating plate temperature in different regions.

### DETAILED DESCRIPTION

Examples of the invention relate to a hair straightening device. Such a device may be used to straighten hair. Needless to say, the same induction heating system described herein may find application in other hair styling devices, such as hair curling or hair crimping devices.

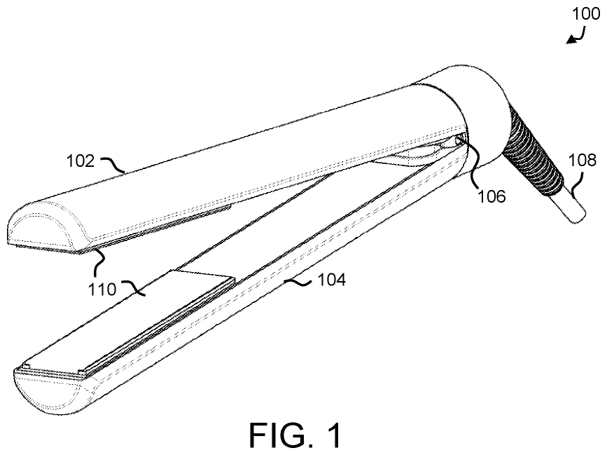

FIG. 1 is a perspective view of a hair straightening device 100 comprising a first arm 102 and a second arm 104, which are joined together at one end by a hinge 106. A power supply cable 108 extends away from the hinged end of the hair straightening device 100. In other examples, the hair straightening device 100 comprises an internal battery power source, such that the power supply cable 108 is omitted.

Each arm 102, 104 comprises an induction heating plate 110 located towards the end of the arm furthest away from the hinge 106. FIG. 1 shows the hair straightening device 100 in an open position where the heating plates 110 are spaced apart. The heating plates 110 are arranged to contact each other when the first and second arms 102, 104 are brought together by a user into a closed position. The heating plates 110 comprise a hair contacting surface which contacts hair, in use. Hair that is to be straightened is trapped between the two heating plates 110 and heat is transferred to the hair from the heating plates 110.

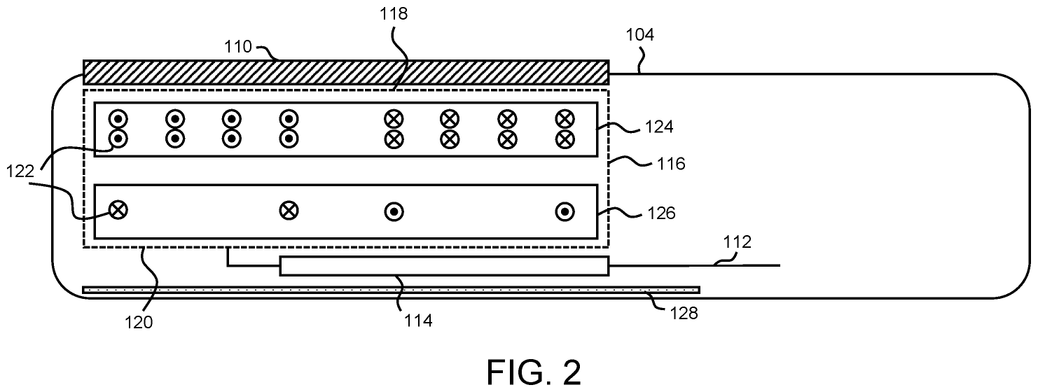

FIG. 2 depicts a cross section of the second arm 104 of FIG. 1. Wiring 112 from a power source connects to a PCB 114, which contains control electronics. Mounted on the PCB 114 is a controller (not shown) that controls operation of the hair straightening device 100.

Each arm 102, 104 comprises an induction heating assembly 116 spaced apart from the heating plate 110. The induction heating assembly 116 is configured to generate a varying magnetic field that penetrates the induction heating plate 110. As mentioned, the magnetic field induces eddy currents within the electrically conductive heating plate 110 which causes the heating plate 110 to heat up. The heating assembly 116 has a top side 118 that faces the heating plate 110, and a bottom side 120 that faces away from the heating plate 110.

In some examples of the invention, the magnetic field generated by the induction heating assembly is asymmetric, meaning that the magnetic field strength at the top side 118 is substantially greater than the magnetic field strength at the bottom side 120. Thus, a greater percentage of the magnetic flux impinges the heating plate 110 when compared to a symmetric magnetic field.

The particular heating assembly 116 depicted in FIG. 2 generates an asymmetric magnetic field and comprises an inductor coil assembly having a number of windings of a conductor 122. When the inductor coil assembly is supplied with a high frequency current, the inductor coil assembly generates an alternating/varying magnetic field. In this example, the conductor 122 is a litz wire comprising a plurality of twisted wire strands. As is well known, a litz wire is designed to reduce high frequency AC losses, such as skin and proximity effects within the conductor. To achieve the asymmetric magnetic field, the inductor coil assembly comprises a power coil layer 124 and a screening coil layer 126. In general terms, the power coil layer 124 is designed to generate a sufficiently strong magnetic field to heat the heating plate 110, and the screening coil layer 126 is designed to generate an opposing magnetic field to cancel out or sufficiently reduce the magnetic flux passing out of the bottom side 120 of the heating assembly 116. At any point along the heating assembly 116, the current passing through the conductor windings in the screening coil layer 126 is opposite to the current passing through the conductor windings in the power coil layer 124. The current flowing in the opposite direction in the screening coil layer 126 creates an opposing magnetic field.

In FIG. 2, the power coil layer 124 comprises two layers of four windings of a single conductor 122 which form a spiral shape when viewed from above. The conductor 122 is therefore wound into and out of the page. In windings where the current flows out of the page at an instance in time, the conductor 122 is shown illustrated with a dot in its centre. In windings where the current flows into the page at the same instance in time, the conductor 122 is shown with a cross. It will be understood that the current is alternating, so the direction of the current is reversed in accordance with a drive frequency. The screening coil layer 126 comprises one layer of two windings of the same conductor 122. To ensure that the magnetic field is asymmetric, the current density in the power coil layer 124 is greater than the current density in the screening coil layer 126. The magnetic field created by the power coil layer 124 is therefore stronger than the magnetic field created by the screening coil layer 126. The form of the magnetic field can be adjusted by altering the current density and/or positions of the conductors 122 in each layer 124, 126. Accordingly, it will be appreciated that the number of windings in each coil layer 124, 126 may be different to that illustrated in FIG. 2.

In this particular example, a single conductor 122 forms both the power coil 124 and the screening coil layer 126. In other examples, two or more conductors may be used. For example, a single conductor may form the power coil layer 124 and a different conductor may form the screening coil layer 126. In some examples, two or more conductors may be used within each layer 124, 126.

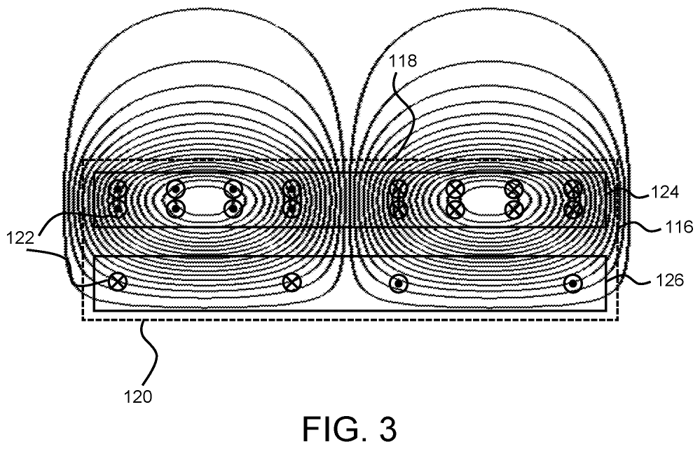

FIG. 3 depicts an example asymmetric magnetic field generated by the heating assembly 116 of FIG. 2. The heating plate 110 is omitted so that the single sided nature of the magnetic field is more clearly visible. Introducing the heating plate 110 would distort the magnetic field from that shown in FIG. 3 (particularly in the top side 118) as the magnetic flux is absorbed by the heating plate 110.

The magnetic fields generated by the power coil layer 124 and the screening coil layer 126 combine to produce an overall asymmetric magnetic field which has a magnetic field strength at the top side 118 that is substantially greater than the magnetic field strength at the bottom side 120. Visually, this asymmetric magnetic field is shown by no, or a reduced number of magnetic field lines extending beyond the bottom side 120 of the heating assembly 116. As such, a high proportion of the magnetic energy is directed towards the induction heating plate 110 and the magnetic flux escaping the device is greatly reduced. FIG. 2 therefore shows an optional, thin layer of magnetic shielding 128 arranged below the bottom side 120 of the heating assembly 116. Without the asymmetric magnetic field, the shielding 128 would need to much thicker, which results in a bulkier, heavier and more expensive hair straightening device 100.

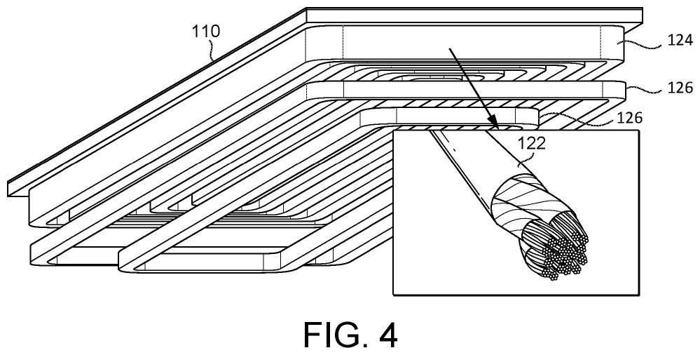

FIG. 4 is a perspective view of the induction heating assembly 116 of FIGS. 2 and 3 to more clearly illustrate the power coil layer 124 and the screening coil layer 126 in proximity to the heating plate 110.

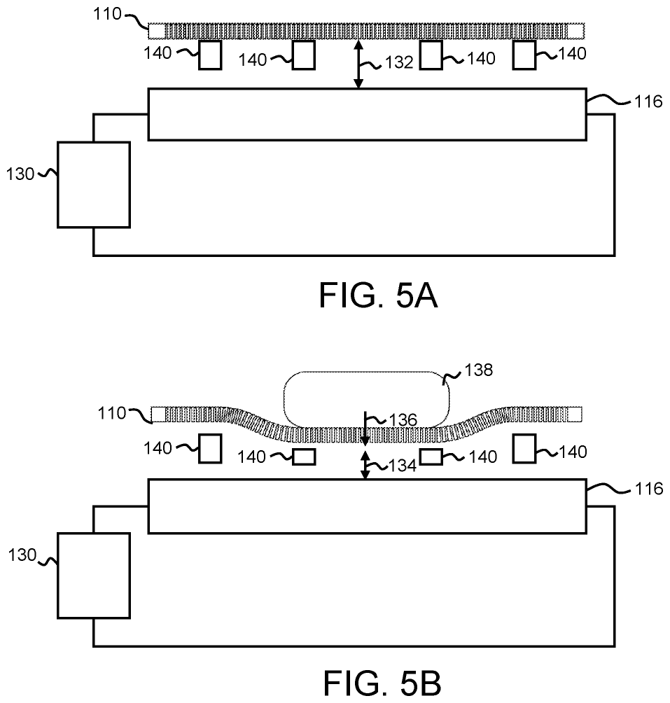

As mentioned, the inductor coil assembly is supplied with a high frequency current, so the heating assembly 116 therefore further comprises a drive circuit 130 (shown in FIGS. 5A and 5B) mounted on the PCB 114. The drive circuit 130 is used to provide and control the current flow through the inductor coil assembly. The alternating current provided to the inductor coil assembly by the drive circuit is at a particular frequency, which may be known as the drive frequency. As will be well understood, an inductor coil forms part a system that can be driven to resonance, and the heating assembly 116 therefore has an associated resonant frequency. As will be discussed in more detail below, when the drive frequency matches the resonant frequency of the heating assembly 116, the heating plate 110 can be heated most effectively.

In a particular example, the heating plate 110 is flexible such that a force applied to the heating plate 110 causes the heating plate 110 to flex. The flexible heating plate 110 may be useful to conform to the hair to avoid over compression. FIGS. 5A and 5B depict a flexible heating plate 110. In FIG. 5A, the heating plate 110 is arranged in a first position in which the heating plate 110 is substantially flat and unflexed. The heating plate 110 is arranged at a first distance 132 away from the heating assembly 116. In FIG. 5B, the heating plate 110 is arranged in a second position in which a region of the heating plate 110 has been bent or flexed towards the heating assembly 116. A particular region of the heating plate 110 is therefore closer to the heating assembly 116 in the second position when compared to the first position, and is arranged at a second distance 134 away from the heating assembly 116. The second distance 134 is smaller than the first distance 132. The heating plate 110 can move from the first position to the second position upon application of a force 136 by a volume of hair 138. Upon removal of the hair 138, and therefore the force 136, the heating plate 110 is configured to return to the first position depicted in FIG. 5A. One or more biasing members 140, such as springs or resilient members, may urge the heating plate 110 back towards the first position. The heating plate 110 is therefore biased towards the first position, in this example.

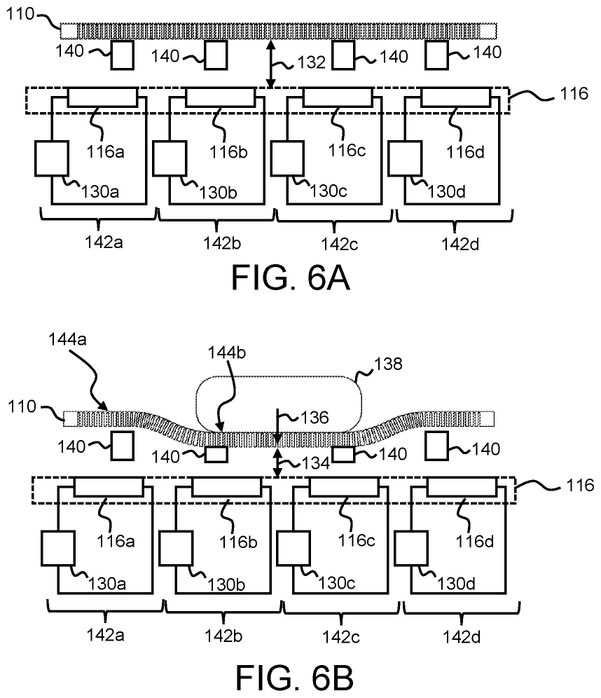

The flexible heating plate 110 finds particular use in an induction heating assembly to control the level of heating of the heating plate 110. FIGS. 6A and 6B depict an induction heating assembly 116 comprising a plurality of heating zones 142a-d, where each heating zone 142a-d is arranged to generate a varying magnetic field to heat a respective region of the heating plate 110. In the example of FIGS. 6A and 6B, there are four heating zones 142a-d, each comprising an inductor coil assembly 116a-d and a drive circuit 130a-d. Each heating zone 142a-d is therefore individually controllable. In other examples, a single drive circuit may drive all of the inductor coil assemblies. In this example, each heating zone 142a-d is capable of producing an asymmetric magnetic field. The magnetic field from each inductor coil assembly 116a-d is directed towards a particular region/area of the heating plate 110 to primarily heat that particular region.

In FIG. 6A, the heating plate 110 is arranged in a first, unflexed position and the drive circuit 130a-d of each heating zone 142a-d drives each heating zone 142a-d at a particular drive frequency. For example, a first heating zone 142b is driven at a first drive frequency and a second heating zone 140a is driven at a second drive frequency. In this example, each heating zone 142a-d is driven at substantially the same drive frequency.

As mentioned above, each heating zone 142a-d has a particular resonant frequency. When the drive frequency of a drive circuit matches the particular resonant frequency of the heating zone, the respective region of the heating plate 110 heated by the heating zone is heated resonantly. This resonant heating manifests itself as a higher heating plate 110 temperature. The greater the difference between the drive frequency and the resonant frequency in a heating zone 142a-d, the less the region is heated.

In FIG. 6A, the drive frequencies of each heating zone 142a-d are selected to avoid resonant heating. For example, the drive frequency of each heating zone 142a-d is substantially far away from the resonant frequencies of each respective heating zone 142a-d. Accordingly, each of the four regions of the heating plate 110 are poorly heated by their respective heating zones 142a-d, such that the temperature of heating plate 110 in each region is relatively low. The temperature may be below a threshold temperature required to straighten hair, for example. The temperature may be at a level to avoid serious burns, should a user accidentally touch the heating plate 110. The temperature may be at a level to reduce the likelihood of nearby objects being burnt, melted or set on fire, should the hair straightening device come into contact with the object. For example, the temperature may be below the combustion temperature of common household objects, such as clothing, wood or carpet. The heating plate 110 temperature in this unflexed “default” position can be predetermined by a manufacturer by choosing a particular drive frequency.

In FIG. 6B, the heating plate 110 is flexed, such that certain regions of the heating plate 110 are arranged in a second position that is closer to the heating assembly 116 than in the first, unflexed position of FIG. 6A. For example, a first, inner region 144b of the heating plate 110 heated by the first heating zone 142b is arranged in a second, flexed position, whereas a second, outer region 144a of the heating plate 110 heated by the second heating zone 142a is arranged substantially in the first, unflexed position.

Moving the position of the heating plate 110 within the magnetic field produced by a particular heating zone 142a-d changes the resonant frequency of that heating zone 142a-d. In this example, when the heating plate 110 is moved from the first position in FIG. 6A to the second position in FIG. 6B, the resonant frequency of the first heating zone 142b changes to a frequency that is closer to the drive frequency of the first heating zone 142b. The resonant frequency in FIG. 6B may be referred to as a “final resonant frequency”, whereas the resonant frequency in FIG. 6A may be referred to as an “initial resonant frequency”. Thus, for the first heating zone 142b, the difference between the drive frequency and the final resonant frequency in the flexed position is substantially smaller than the difference between the drive frequency and the initial resonant frequency in the unflexed position. This smaller difference results in greater heating of the first region 144b of the heating plate 110. If the difference is substantially zero, full or perfect resonance is achieved. If the difference is small enough, some resonant heating will occur. Thus, as the heating plate 110 flexes, the first region 144b is heated to a relatively high temperature, which heats the hair 138 in this region.

While the first region 144b is arranged in the second, flexed position, the second region 144a remains substantially in the first, unflexed position. The second heating zone 142a therefore has a final resonant frequency that is substantially the same as its initial resonant frequency (i.e. the resonant frequency of the second heating zone 142 remains substantially the same). Accordingly, unlike for the first heating zone 142b, the drive frequency of the second zone 142a is still substantially different to the resonant frequency, so as not to cause resonant heating of the second region 144a. Thus, where there is no hair and no flexing (such as in the second region 144a), the temperature of the heating plate 110 remains relatively low. Accordingly, FIGS. 6A and 6B depict a hair straightening device in which the presence of hair causes the heating plate 110 to be heated to a higher extent.

It will be appreciated that in some instances, as the first region 144b flexes, a small amount of flexing of the second region 144a may also be experienced. In this example, the drive frequency remains substantially the same as the heating plate 110 is flexed between the first and second positions shown in FIGS. 6A and 6B.

In the above example, the drive frequency of each heating zone 142a-d may remain the same throughout the heating session (i.e. as the heating plate 110 flexes). The resonant frequency of a heating zone 142a-d changes as the heating plate 110 flexes in its vicinity, and approaches the drive frequency. So, in heating zones where the drive frequency matches the resonant frequency at a certain degree of flex, more efficient heating will occur at this point. This system provides a simple way of controlling the level of heating, but assumes that the heating plate in the vicinity of each heating zone 142a-d will flex by the same amount each time. This approximation therefore assumes that the drive frequency will match resonant frequency in each heating zone as the plate flexes. However, this may not always be the case. For example, in some circumstances, the heating plate 110 may not fully flex, so the resonant frequency does not match the drive frequency and the heating plate 110 is heated less efficiently. In addition, each device that is manufactured will have different components and so the resonant frequency and optimal drive frequency will need to be determined for every device. The resonant frequency may also change over time, as components of the device age. To overcome this, in some examples, the drive frequency of one or more heating zones 142a-d may be adjusted or “tuned” as the heating plate flexes to ensure that it matches the resonant frequency more closely. The drive frequency can therefore be selected as the hair straightening device is used. This “fine-tuning” process will now be described by reference to an example.

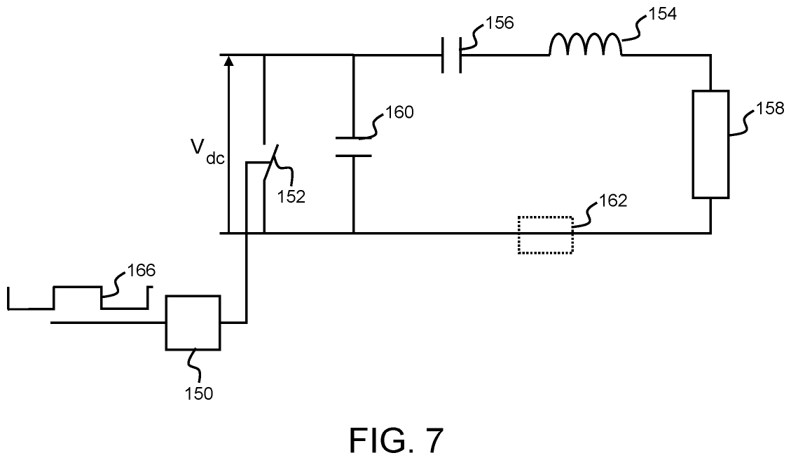

FIG. 7 depicts an equivalent circuit representative of a drive circuit 130, an induction heating assembly 116 and a heating plate 110. The circuit comprises a driver 150 and a switch 152 arranged to supply a high-frequency current at a predetermined drive frequency, f, to the induction heating assembly. To achieve this, a signal 166 supplied to the driver 150 controls the rate at which the switch 152 is operated, and therefore the rate at which a current is applied from a DC voltage source V_{dc}. The driver 150 and the switch 152 may form at least part of the drive circuit 130, for example. The circuit further comprises an inductor 154 (i.e. one or more inductor coils forming an inductor coil assembly) and a series capacitor 156. A load 158 represents the inherent resistances in the circuit, as well as the heating plate 110. The resistance of the load 158 will therefore vary as the heating plate flexes. The inductor 154, the series capacitor 156 and the load 158 form at least part of a resonant circuit (or an “RLC circuit”) that is supplied with the high frequency drive current. The circuit of FIG. 7 therefore comprises two parts: a drive circuit 130 and an RLC circuit. Each heating zone 142a-d therefore comprises an RLC circuit that has an associated resonant frequency that varies based on the flex of the heating plate 110. As is well known, when an RLC circuit is supplied with a high frequency current, the RLC circuit oscillates.

In some examples, the circuit also comprises a shunt capacitor 160, which may from part of the drive circuit 130.

As mentioned above, the drive frequency of the drive circuit 130 can be altered by controlling the rate at which the switch 152 is operated. The drive frequency can be set and controlled by a controller, for example. To achieve resonant heating of the heating plate 110, the drive frequency can be selected to match the resonant frequency of the RLC circuit, which dependents on the flex of the heating plate 110. It may therefore be desirable to determine/calculate the resonant frequency of the RLC circuit and adjust the drive frequency appropriately. The resonant frequency can be calculated at any moment in time by measuring the current and/or voltage at certain locations within the circuit and inputting these parameters into well known, standard equations. However, calculating this many times per second (as the heating plate 110 flexes) can be computationally burdensome. A more computationally efficient method of matching the drive frequency to the resonant frequency can be achieved by determining a phase difference between the RLC circuit current (or voltage) and the drive signal 166, as will be described below. This method relies on inferring when the drive frequency corresponds to the resonant frequency of the RLC circuit by determining the phase difference between the RLC circuit current (or voltage) and the drive signal 166, and comparing this to a predetermined phase difference. This predetermined phase difference is the phase difference when the RLC circuit is resonant, and can be determined in advance empirically or via a computer simulation of the circuit. The drive frequency can be adjusted and when the measured phase difference matches the predetermined phase difference, it can be deduced that the RLC circuit is resonant (i.e. the currently selected drive frequency equals the resonant frequency). It has been found that inferring resonance via the phase difference is more efficient than calculating the resonant frequency directly.

While the phase difference could be determined between the RLC circuit current (or voltage) and the voltage across the capacitor 160, this can in practice be noisy, and less reliable. It is therefore preferred to determine the phase difference between the RLC circuit current (or voltage) and the pure drive signal 166.

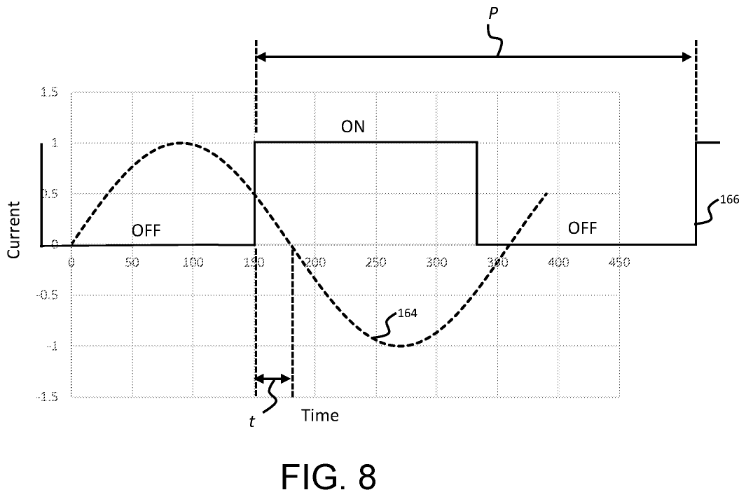

FIG. 8 depicts a plot of the measured RLC circuit current 164 over time (both axes with arbitrary units). The RLC circuit current 164 can be measured at point 162 in FIG. 7, which is at zero voltage reference. In a particular example, the current can be measured/determined by introducing a shunt resistor with a known resistance into the RLC circuit and measuring the voltage across the shunt resistor. The current can therefore be determined based on the voltage across the shunt resistor.

FIG. 8 also shows the points in time at which the switch 152 is closed (on) and open (off). In this particular example, the driver 152 receives a square wave signal 166 (from a controller, for example) with a 50% duty cycle which causes the switch 152 to turn on for a period of time and turn off for the same period of time. This signal may be known as a drive signal 166, and may take many different forms. When the switch 152 is on (closed), the voltage across the shunt capacitor 160 is 0V and when the switch 152 is off (open), the voltage across the shunt capacitor 160 is V_{dc}.

FIG. 8 shows the switch 152 being turned on and off with a time period, P. The drive frequency, f, is therefore 1/P. The RLC circuit current 164 also oscillates with the same time period.

As a result of this switching, the current and voltage through the RLC circuit is sinusoidal in nature as the RLC circuit oscillates. This sinusoidal waveform is shown in FIG. 8. It can be seen that these oscillations are out of phase with the drive frequency. That is, the sign of the current/voltage does not change at the same time as when the switch turns on/off. Instead, there is a time delay, t, as shown in FIG. 8. This time delay can be determined by timing the difference between the zero crossing point of the RLC circuit current 164 and the zero crossing point of the drive signal 166. This time difference can be converted to an angular phase difference using the time period, P, of the drive signal 166. In this particular example, the angular phase difference is about 30 degrees. If the drive frequency changes, the measured phase difference will change, provided the heating plate flex remains the same. Similarly, if the heating plate flex changes (which changes the resonant frequency of the RLC circuit) and the drive frequency remains constant, the measured phase difference changes. The phase difference is therefore dependent on the relationship between the drive frequency and resonant frequency.

Circuit theory and experimental data shows that the phase difference at resonance (for a given circuit) remains substantially the same regardless of the resonant frequency. For example, if the heating plate 110 were initially flexed by a first distance and were heated resonantly, the phase difference at resonance would have a certain value. If the heating plate 110 were flexed further, by a second distance and were also heated resonantly, the phase difference would be the same as found previously. The phase difference at resonance (or the “resonance phase difference”) can be determined prior to operation empirically or via a simulation, as mentioned above. Accordingly, if the measured phase difference matches the predetermined phase difference at resonance, it can be inferred that the drive frequency matches the resonant frequency. This means that the heating plate 110 can be heated resonantly by selecting a drive frequency that results in the measured phase difference matching this predetermined phase difference at resonance. In practice this can be achieved by: (i) initially selecting a suitable drive frequency, (ii) measuring the phase difference, (iii) comparing this to the predetermined phase difference at resonance, and (iv) making small adjustments to the drive frequency until the measured phase difference matches the predetermined phase difference at resonance. The process of varying the drive frequency until the measured phase difference matches the predetermined phase difference at resonance can be achieved using a PID controller, for example.

Step (i) can involve the controller supplying the drive circuit (i.e. the driver 150) with a particular drive signal, which in turn causes the drive circuit to supply alternating current at a particular drive frequency to the RLC circuit. Step (ii) can involve the controller determining a phase difference between a current (or voltage) of the RLC circuit and the particular drive signal, as described above. Step (iii) can involve the controller determining whether the phase difference corresponds to a predetermined phase difference. For example, determining whether the phase difference close to the predetermined phase difference (i.e. within a particular range). If the phase difference corresponds to the predetermined phase difference, it may be assumed that the particular drive frequency corresponds to a resonant frequency of the RLC circuit. However, if the phase difference does not correspond to the predetermined phase difference, then step (iv) can involve supplying the drive circuit with a different drive signal, thereby causing the drive circuit to supply alternating current at a different drive frequency. This can be repeated iteratively until the phase difference corresponds to the predetermined phase difference.

Accordingly, the resonant frequency can be inferred from the phase difference, without needing to calculate the resonant frequency directly, which has been found to be a more computationally efficient method of determining the resonant frequency.

As briefly mentioned, the predetermined phase difference at resonance can be determined via one of two methods. In a first method, the physical system (i.e. the hair styling device) can be modelled using an electronic circuit simulator that has properties representative of the physical system. For example, the circuit of FIG. 7 can be built and represented in a computer simulation. In the simulation, the resonant frequency of the RLC circuit can be calculated using well known standard equations, and can be supplied with a matching drive frequency so that it is driven to resonance. In the same way as described above, the phase difference between the simulated RLC circuit current (or voltage) and the simulated drive signal can be determined at resonance. This phase difference is therefore the phase difference at resonance (i.e. when the RLC circuit is resonant). Assuming the model is accurate, this “simulated phase difference at resonance” should be the same as the phase difference at resonance of the physical circuit, and can be stored in memory by the controller of the physical hair styling device. In the physical device, the predetermined phase difference at resonance is therefore this simulated phase difference at resonance.

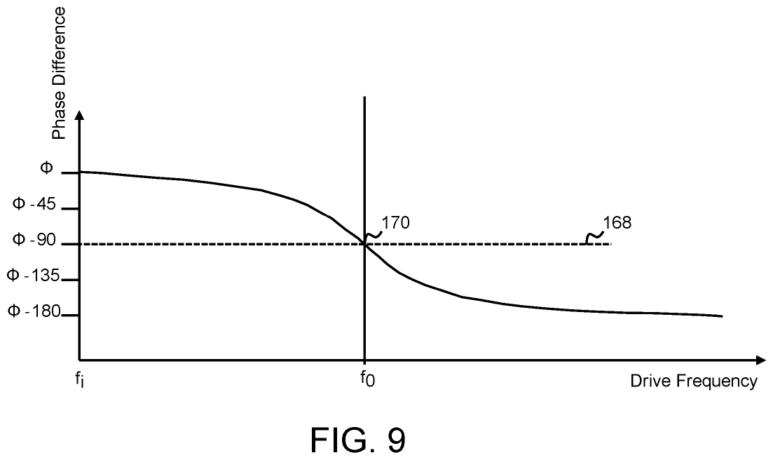

In a second method, the predetermined phase difference at resonance can be determined by the physical system before the device is used (i.e. before a user styles their hair and/or before the heating plate 110 has flexed) by causing the drive circuit to sweep through a range of drive frequencies and for each frequency, measuring/determining a phase difference using the method described above. As the drive frequency changes, the drive frequency will get closer to, or further away from the RLC resonant frequency (which will be unknown). As is best observed in a Bode Plot, such as the Bode Plot of FIG. 9, as the drive frequency is swept through the RLC resonant frequency, f₀ the measured phase difference varies rapidly, and shifts by 90 degrees from an initial phase difference, Φ, (measured at a drive frequency, fᵢ, far from the resonant frequency). By sweeping through a range of drive frequencies, the phase difference can be determined for each drive frequency, and the predetermined phase difference at resonance 168 can be found. As shown in FIG. 9, the system is at resonance when the phase difference changes from an initial value, Φ, by 90 degrees, where the drive frequency equals the resonant frequency f₀. The predetermined phase difference at resonance, Φ₀, is therefore given by: Φ₀=Φ−90, where Φ is the phase difference at a drive frequency, fᵢ, far from the resonant frequency. Φ will be different for each circuit. Φ₀ can also found by sweeping through a range of drive frequencies around the resonant frequency, estimating the resonant frequency as the midpoint 170 in the slope of the graph, and determining the phase difference at this frequency. Alternatively, Φ₀ may be found by initially determining the phase difference at a drive frequency fᵢ, sufficiently far from the estimated/expected resonant frequency f₀, and by shifting this by 90 degrees. In a particular example, a drive frequency fᵢ, sufficiently far from the estimated/expected resonant frequency f₀, is around 100 times larger or smaller than the expected resonant frequency. For example, if the expected resonant frequency, f₀, is around 700-800 kHz, fᵢ may be around 10 kHz.

In this second method, the predetermined phase difference at resonance may be determined periodically to account for any variances over time as the device ages. For example, the predetermined phase difference at resonance may be determined each time the device is switched on, or once every day, week, month, etc. The manufacturer of the device may determine how often this is recalibrated.

Once the predetermined phase difference at resonance has been found, the device can be used and the drive frequency adjusted during operation to ensure that the heating plate 110 is heated resonantly by ensuring that the measured phase difference matches the predetermined phase difference.

The above process therefore describes how the drive frequency can be “fine-tuned” as the heating plate 110 flexes. For example, the heating plate 110 may initially flex by a first distance as the user is styling a portion of hair and the drive frequency can be selected to resonantly heat the heating plate 110. The user may then style another portion of hair, and the heating plate 110 flexes by a second distance. Again, a different drive frequency can be selected to resonantly heat the heating plate 110. Thus, rather than keeping a constant drive frequency and assuming that it will match the resonant frequency of the RLC circuit when the heating plate 110 flexes, a more appropriate “fine-tuned” drive frequency can be found to ensure more efficient heating.

In some examples, the drive circuit 130 of a heating zone 142a-d may be switched off if the heating plate 110 is not flexed in that region. This avoids heating the unflexed regions of the heating plate 110. For instance, in the examples where the drive frequency of each heating zone 142a-d is fixed, the heating plate 110 in unflexed regions is heated to a low temperature, rather than being heated resonantly. This minimal heating still consumes energy, so should be avoided if possible. Accordingly, in some examples, the controller is configured to determine whether a region of the heating plate heated by a heating zone is flexed (i.e. arranged in the first, unflexed position, or in the second, flexed position), and if not, cause the induction heating assembly of that particular heating zone to stop generating a magnetic field. This may be achieved by ceasing to supply the drive signal 166 to the driver 150, thus causing the drive circuit to be switched off. Other methods of stopping the generation of a magnetic field may also be used.

The controller may implement at least one method to determine whether the heating plate 110 is flexed in the vicinity of a heating zone. In a first method, the impedance of the inductor coil 154 in the RLC circuit is used to determine whether the heating plate 110 is flexed in the vicinity of a heating zone. The impedance, Z_{L}, can be determined by the complex solution to Z_{L}=V_{L}/I, where V_{L} is the voltage across the inductor 154 and I is the RLC circuit current 164 as described earlier. As the heating plate 110 flexes, the impedance changes from an initial value determined when the heating plate 110 has not been flexed. The impedance may change due to a change in effective inductance, L, as the heating plate moves relative to the inductor coil, causing the amount of leakage fluxes in the circuit to change. The initial impedance before flex (a “reference impedance”) can be calculated via simulation and stored in memory for use by the controller, or may be determined/measured when the device is initially switched on. The measured impedance is then compared to the reference impedance, and if the measured impedance varies from the reference impedance by a threshold amount, it may be determined that the heating plate has flexed. The impedance of the inductor coil may be known as a load impedance, in some examples. If the measured impedance substantially corresponds to the reference impedance (i.e. varies by less than a threshold amount), it may be determined that the heating plate has not flexed.

In a second method, the power delivered to the RLC circuit is used to determine whether the heating plate 110 is flexed in the vicinity of a heating zone. The average power, W, supplied by the drive circuit 130 can be determined by W=Iᵣₘₛcos(φ)*Vᵣₘₛ, where φ is the phase between the voltage and the current supplied by the drive circuit 130, Vᵣₘₛ is the is the RMS voltage and Iᵣₘₛ is the RMS current. Vᵣₘₛ and Iᵣₘₛ both dependent on the drive frequency. If the RLC circuit is heated resonantly, cos(φ)=1. Thus, by measuring and calculating Iᵣₘₛ and Vᵣₘₛ at resonance, the power supplied at resonance can be determined. If the heating plate 110 is unflexed and heated resonantly (by selecting an appropriate drive frequency), the power supplied by the drive circuit can be determined. If the heating plate 110 is flexed and is also heated resonantly (by selecting a different drive frequency), the power supplied will be different to that previously determined. The power supplied by the drive circuit at resonance therefore depends on the degree of heating plate flex. The initial power before flex (a “reference power”) can be determined/measured when the device is initially switched on. If the measured power varies from the reference power by a threshold amount, it may be determined that the heating plate has flexed.

Determining the power before flex inherently requires the heating plate 110 to be heated resonantly, which causes the heating plate 110 to be heat up. Accordingly, preferably, this heating is performed over short period, so that the temperature remains relatively low. This saves energy and avoids potentially burning a user.

In some examples, the controller is configured to determine whether the heating plate 110 is flexed in the vicinity of a heating zone periodically. For example, the controller may determine the impedance and/or power for a heating zone every second, and if it is determined that the heating plate 110 remains unflexed, the induction heating assembly of that particular heating zone remains inactive (i.e. does not generate a magnetic field).

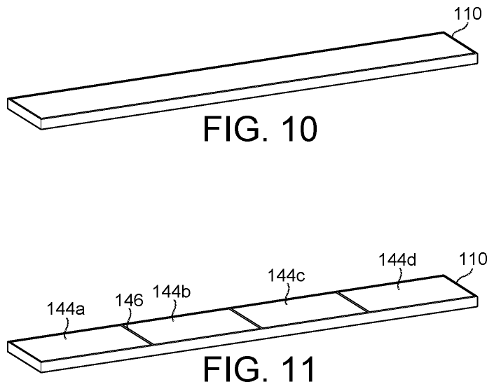

Returning to FIG. 6B, it can be some regions of the heating plate 110 may be heated to a greater extent than other regions. It may be useful to limit heat flow between adjacent regions in some instances. Therefore, in some examples, the surface of the heating plate that contacts the hair may have one or more insulating boundaries separating different regions on the heating plate 110 to reduce heat flow between regions. FIG. 10 depicts a heating plate 110 without insulating boundaries, whereas FIG. 11 depicts an insulating boundary 146 between each region. For example, FIG. 11 depicts an insulating barrier 146 separating the first and second regions 144a, 144b. In this particular arrangement, the insulating boundary is a groove formed on the heating plate such that the surface of the heating plate that contacts the hair may has a non-continuous surface. The groove may be integrally formed, or may be etched or milled from the heating plate 110.

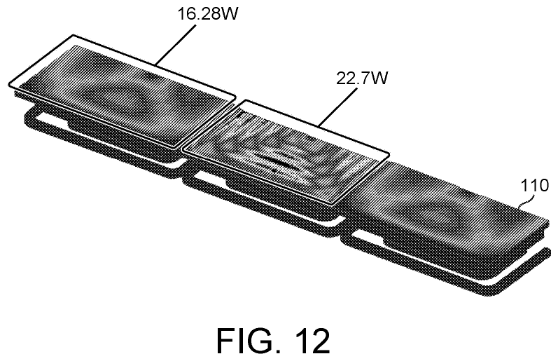

FIG. 12 depicts a heat map of the surface of an example heating plate having three heating zones that heats three respective regions on the heating plate 110. The central region is arranged in the second, flexed position and is thus being heated resonantly. The temperature of the heating plate 110 in this central region is therefore higher than that of the two adjacent regions which remain unflexed.

The above examples are to be understood as illustrative. Further examples are envisaged. Any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

1. A hair styling device for heating hair, comprising:
an induction heating plate arranged to be heated by penetration with a varying magnetic field; and
an induction heating assembly having a top side facing towards the heating plate, and a bottom side facing away from the heating plate, wherein the induction heating assembly is configured to generate a varying magnetic field, the varying magnetic field being asymmetric such that the magnetic field strength at the top side is substantially greater than the magnetic field strength at the bottom side.

2. The hair styling device according to claim 1, wherein a ratio of the magnetic field strength at the top side to the magnetic field strength at the bottom side is greater than about 100.

3. The hair styling device according to claim 1, wherein the induction heating assembly comprises a plurality of heating zones, each heating zone being arranged to generate a varying magnetic field to heat a respective region of the heating plate.

4. The hair styling device according to claim 3, wherein each heating zone is independently controllable.

5. The hair styling device according to claim 1, wherein the heating plate is flexible.

6. The hair styling device according to claim 5, wherein the heating plate is moveable between a first position and a second position, the second position being closer to the induction heating assembly than the first position, and wherein:
the heating plate is biased towards the first position in the absence of a force applied by hair; and
the heating plate is deflected towards the second position in the presence of a force applied by hair.

7. The hair styling device according to claim 6, when appendant to claim 3 or 4, wherein the plurality of heating zones comprises a first heating zone driven at a first drive frequency, wherein:
when a first region of the heating plate heated by the first heating zone is arranged in the first position, the first heating zone has an initial resonant frequency; and
when the first region is arranged in the second position, the first heating zone has a final resonant frequency, wherein the difference between the final resonant frequency and the first drive frequency is smaller than the difference between the initial resonant frequency and the first drive frequency, thereby causing resonant heating of the first region.

8. The hair styling device according to claim 7, wherein the plurality of heating zones comprises a second heating zone driven at a second drive frequency, wherein:
when the first region is arranged in the first position:
a second region of the heating plate heated by the second heating zone is arranged in the first position; and
the second heating zone has an initial resonant frequency; and
when the first region is arranged in the second position:
the second region remains substantially in the first position; and
the second heating zone has a final resonant frequency substantially the same as the initial resonant frequency; and
the second drive frequency is substantially different to the final resonant frequency, so as not to cause resonant heating of the second region.

9. The hair styling device according to claim 8, wherein the first and second drive frequencies are substantially the same.

10. The hair styling device according to claim 7, wherein the first heating zone comprises:
a drive circuit configured to supply alternating current at a drive frequency according to a drive signal; and
a resonant circuit driven by the drive circuit, the resonant circuit being arranged to heat the first region of the heating plate; and
wherein the hair styling device further comprises a controller configured to, when the first region is arranged in the second position:
supply the drive circuit with a particular drive signal, thereby causing the drive circuit to supply alternating current at a particular drive frequency;
determine a phase difference between a current or voltage of the resonant circuit and the particular drive signal;
determine whether the phase difference corresponds to a predetermined phase difference; and
if the phase difference corresponds to the predetermined phase difference:
determine that the particular drive frequency corresponds to a resonant frequency of the resonant circuit; and
if the phase difference does not correspond to the predetermined phase difference:
supply the drive circuit with a different drive signal, thereby causing the drive circuit to supply alternating current at a different drive frequency.

11. The hair styling device according to claim 10, wherein the predetermined phase difference is a phase difference between a current or voltage of the resonant circuit and the drive signal when the resonant circuit is resonant.

12. The hair styling device according to claim 10, wherein the controller is configured to determine the predetermined phase difference when the first region is arranged in the first position by being configured to:
supply the drive circuit with a particular drive signal, thereby causing the drive circuit to supply alternating current at a particular drive frequency, the particular drive frequency being sufficiently far from an estimated resonant frequency of the resonant circuit;
determine a measured phase difference between a current or voltage of the resonant circuit and the particular drive signal; and
determine the predetermined phase difference as being the measured phase difference offset by 90 degrees.

13. The hair styling device according to claim 10, wherein the predetermined phase difference is calculated via a computer simulation.

14. The hair styling device according to claim 10, wherein the controller is further configured to determine whether the first region of the heating plate is arranged in the first position or the second position.

15. The hair styling device according to claim 14, wherein if it is determined that the heating plate is arranged in the first position, the controller is configured to cause the first heating zone being arranged to cease generating a magnetic field.

16. The hair styling device according to claim 14, wherein the resonant circuit comprises an inductor coil assembly, and wherein the controller is configured to determine whether the first region of the heating plate is arranged in the first position or the second position based on a comparison of an impedance of the inductor coil assembly with a reference impedance.

17. The hair styling device according to claim 14, wherein the controller is configured to determine whether the first region of the heating plate is arranged in the first position or the second position by being configured to:
determine an average power supplied by the drive circuit when the when the resonant circuit is resonant; and
determine whether the first region of the heating plate is arranged in the first position or the second position based on a comparison of the average power to a reference power.

18. The hair styling device according to claim 8, wherein the first and second regions are separated by an insulating boundary to reduce heat flow between the first and second regions.

19. The hair styling device according to claim 18, wherein the insulating boundary comprises a groove formed on the heating plate.

20. A hair styling device for heating hair, comprising:
a flexible induction heating plate configured to be heated by penetration with a varying magnetic field; and
an induction heating assembly configured to generate a varying magnetic field, the induction heating assembly comprising a first heating zone to heat a first region of the heating plate, and a second heating zone to heat a second region of the heating plate;
wherein:
the first and second regions of the heating plate are independently moveable between a first position and a second position, the second position being closer to the heating assembly than the first position, wherein the first and second regions are biased towards the first position in the absence of a force applied by hair and are deflected towards the second position in the presence of a force applied by hair;
when the first and second regions of the heating plate are arranged in the first position:
the first and second heating zones have a resonant frequency substantially different to a drive frequency driving the first and second heating zones so as not to cause resonant heating of the first and second regions; and
when the first region is arranged in the second position and the second region remains substantially in the first position:
the difference between a resonant frequency of the first heating zone in the second position and the drive frequency is smaller than the difference between the resonant frequency of the first heating zone in the first position and the drive frequency, so as to cause resonant heating of the first region; and
the second heating zone maintains a resonant frequency substantially different to the drive frequency so as not to cause resonant heating of the second region.

21. A hair styling device for heating hair, comprising:
an induction heating plate configured to be heated by penetration with a varying magnetic field; and
an induction heating assembly configured to generate a varying magnetic field, the induction heating assembly comprising a first heating zone to heat a first region of the heating plate, and a second heating zone to heat a second region of the heating plate;
wherein:
the first and second regions are adjacent; and
the first and second regions are separated by an insulating boundary to reduce heat flow between the first and second regions.

22. The hair styling device according to claim 21, wherein the insulating boundary comprises a groove formed on the heating plate.

23. The hair styling device according to claim 21, wherein the hair styling device further comprises a battery power source to power the induction heating assembly.

24. A hair styling device for heating hair, comprising:
a flexible induction heating plate configured to be heated by penetration with a varying magnetic field;
an induction heating assembly comprising:
a drive circuit configured to supply alternating current at a drive frequency according to a drive signal; and
a resonant circuit driven by the drive circuit, the resonant circuit being arranged to generate a varying magnetic field for heating the heating plate; and
a controller;
wherein:
the heating plate is moveable between a first position and a second position, the second position being closer to the induction heating assembly than the first position, wherein the heating plate is biased towards the first position in the absence of a force applied by hair and is deflected towards the second position in the presence of a force applied by hair; and
the controller is configured to, when the heating plate is arranged in the second position:
supply the drive circuit with a particular drive signal, thereby causing the drive circuit to supply alternating current at a particular drive frequency;
determine a phase difference between a current or voltage of the resonant circuit and the particular drive signal;
determine whether the phase difference corresponds to a predetermined phase difference; and
if the phase difference corresponds to the predetermined phase difference:
determine that the particular drive frequency corresponds to a resonant frequency of the resonant circuit; and
if the phase difference does not correspond to the predetermined phase difference:
supply the drive circuit with a different drive signal, thereby causing the drive circuit to supply alternating current at a different drive frequency.

25. A hair styling device for heating hair, comprising:
a flexible induction heating plate configured to be heated by penetration with a varying magnetic field;
an induction heating assembly comprising:
a drive circuit configured to supply alternating current at a drive frequency according to a drive signal; and
a resonant circuit driven by the drive circuit, the resonant circuit being arranged to generate a varying magnetic field for heating the heating plate; and
a controller;
wherein:
the heating plate is moveable between a first position and a second position, the second position being closer to the induction heating assembly than the first position, wherein the heating plate is biased towards the first position in the absence of a force applied by hair and is deflected towards the second position in the presence of a force applied by hair; and
the controller is configured to determine whether the heating plate is arranged in the first position or the second position.

26. The hair styling device according to claim 25, wherein the resonant circuit comprises an inductor coil assembly, and wherein the controller is configured to determine whether the heating plate is arranged in the first position or the second position based on a comparison of an impedance of the inductor coil assembly with a reference impedance.

27. The hair styling device according to claim 25, wherein the controller is configured to determine whether the heating plate is arranged in the first position or the second position by being configured to:
determine an average power supplied by the drive circuit when the when the resonant circuit is resonant; and
determine whether the heating plate is arranged in the first position or the second position based on a comparison of the average power to a reference power.
